(19) United States
(12) Patent Application Publication
(10) Pub. No.: US 2021/0149372 A1
(43) Pub. Date: May 20, 2021

(54) ROBOTS WORKING IN SHIFTS AND SHIFT ROTATION METHOD THEREFOR

(71) Applicant: Electronics and Telecommunications Research Institute, Daejeon (KR)

(72) Inventor: Yong Bon KOO, Daejeon (KR)

(73) Assignee: Electronics and Telecommunications Research Institute, Daejeon (KR)

(21) Appl. No.: 17/098,020

(22) Filed: Nov. 13, 2020

(30) Foreign Application Priority Data
Nov. 14, 2019 (KR) 10-2019-0145599

(51) Int. Cl. G05B 19/4155

(52) U.S. Cl. CPC G05B 19/4155; G05B 2219/34348; G05B 2219/40306

(57) ABSTRACT

Provided is a robot working in shifts, the robot including a storage unit configured to store received work plan information including a work position, work information, and workload information, and a work log created and received by a preceding work robot, a work processing unit configured to move to a work area and then work on the basis of plane information when only the work plan information is present in the storage unit, a log creation unit configured to detect workload performed through the work processing unit and work position information regarding a work position to which the robot has moved for work, create a work log including the detected workload and work position information, and store the created work log in the storage unit; a rotation determination unit configured to determine a shift rotation cycle; and a communication unit configured to establish a communication link with a subsequent robot and transfer the work log stored in the storage unit to the subsequent robot when the rotation determination unit determines that a shift rotation time comes and the subsequent robot approaches the work area.

### CROSS-REFERENCE TO RELATED APPLICATION

This application claims priority to and the benefit of Korean Patent Application No. 10-2019-0145599, filed on Nov. 14, 2019, the disclosure of which is incorporated herein by reference in its entirety.

### BACKGROUND

### 1. Field of the Invention

The present invention relates to robots working in shifts and a shift rotation method therefor.

### 2. Discussion of Related Art

In facilities and spaces such as factories, power plants, and the deep sea, it is necessary to alternately allocate and operate multiple robots because one robot cannot perform a continuous task alone due to durability and power issues.

However, in order for multiple robots to have work continuity, it is necessary to transfer a work log to a subsequent robot. In environments in which robots operate, there are cases in which it is not possible to transfer work logs due to various variables.

In particular, since electronic components of such a robot are highly likely to be damaged due to a harsh environment, a failure to transfer a work log may cause a big problem by affecting work continuity.

In addition, in order to detect an emergency situation in a harsh work area, it is often necessary to have one or more robots in the work area.

### SUMMARY OF THE INVENTION

The present invention is directed to providing a shift rotation process for multiple robots working in shifts, and in particular, a system and method for responding to a failure in the transfer of a work log and allowing one or more robots to monitor work areas.

The present invention is directed to providing a method of at least one robot staying in a work area and monitoring the work area and a robot implementing the same.

The present invention is not limited to the above objectives, but other objectives not described herein may be clearly understood by those skilled in the art from the following description.

According to an aspect of the present invention, there is provided a robot working in shifts, the robot including a storage unit configured to store received work plan information including a work position, work information, and workload information, and a work log created and received by a preceding work robot, a work processing unit configured to move to a work area and then work based on work plan information when only the work plan information is present in the storage unit, a log creation unit configured to detect workload performed through the work processing unit and work position information regarding a work position to which the robot has moved for work, create a work log including the detected workload and work position information, and store the created work log in the storage unit, a rotation determination unit configured to determine a shift rotation cycle, and a communication unit configured to establish a communication link with a subsequent robot and transfer the work log stored in the storage unit to the subsequent robot when the rotation determination unit determines that a shift rotation time comes and the subsequent robot approaches the work area.

When a work log created by the preceding work robot is present in the storage unit, the work processing unit may work in association with work of the preceding work robot on the basis of the work log.

The robot may further include a communication determination unit configured to determine whether log information is normally transferred to the subsequent robot through the communication unit, wherein when the communication determination unit determines that the log information of the work robot is not received, the communication unit may establish a communication link with a standby robot located outside the work area and transfer the work log stored in the storage unit to the standby robot.

When the log information is received from the preceding work robot outside the work area, the work processing unit may move to the work area on the basis of the received log information.

When work log information is not received from the preceding work robot after the work processing unit moves to the work area on the basis of the work plan information stored in the storage unit, the work processing unit may perform only a monitoring function in the work area without working.

When the subsequent robot moves into the work area, the work processing unit may not work and may return from the work area.

The work log may include labeling information of spaces into which the entire work area is divided, location information of the spaces, information on types of work performed over time, and information on progress of each piece of work.

The communication link may use one of wired and wireless communication protocols.

According to another aspect of the present invention, there is provided a shift rotation method for multiple robots working in shifts, the shift rotation method including storing a work log created by a work robot, which is working, establishing a communication link between a communication unit of the work robot and a communication unit of a subsequent robot and transferring the work log to the subsequent robot when the subsequent robot enters a work area to work a next shift, and allowing the work robot to withdraw from the work area. Here, the work log may include labeling information of spaces into which the entire work area is divided, location information of the spaces, information on types of work performed over time, and information on progress of each work.

The communication link may use one of wired and wireless communication protocols.

According to another aspect of the present invention, there is provided a shift rotation method for multiple robots working in shifts, the shift rotation method including storing a work log created by a work robot, which is working, establishing a communication link between a communication unit of the work robot and a communication unit of a subsequent robot and transferring the work log to the subsequent robot when the subsequent robot enters a work area to work a next shift, determining whether the transferring of the work log succeeds or fails, allowing the work robot to withdraw from the work area when it is determined that the transferring of the work log succeeds, and allowing the subsequent robot to resume work on the basis of the work log provided by the work robot.

The shift rotation method may further include allowing the subsequent robot to monitor environmental information in the work area without working in the work area when it is determined that the work log of the work robot is not transferred to the subsequent robot.

The shift rotation method may further include allowing the subsequent robot to monitor the environmental information in the work area and allowing the work robot to move out of the work area, allowing the work robot to establish a communication link with a standby robot outside the work area and transfer the work log of the work robot to the standby robot, allowing the standby robot to enter the work area and approach the subsequent robot, and allowing the subsequent robot, which is monitoring the work area, to withdraw from the work area and allowing the standby robot to resume work in the work area on the basis of the work log provided by the work robot.

The determining of whether the transferring of the work log succeeds or fails may include allowing the work robot to detect whether the subsequent robot approaches within a preset range, allowing the work robot to establish a communication link with the subsequent robot, allowing the work robot to transfer specific preset data to the subsequent robot and then determine whether response data is received from the subsequent robot to check the establishment of the connection with the subsequent robot, allowing the work robot to transfer the work log of the work robot to the subsequent robot when it is determined that the response data is received from the subsequent robot, allowing the work robot to determine whether response data corresponding to the reception of the work log of the work robot is received from the subsequent robot, and determining that the transferring of the work log succeeds when it is determined that the response data corresponding to the reception of the work log is received from the subsequent robot.

The determining of whether the transferring of the work log succeeds or fails may further include determining whether the connection has failed more than a preset number of times when it is determined that the response data is not received from the subsequent robot and checking the connection for transferring the work log when the connection has not failed more than the preset number of times and determining that the transferring of the work log fails when the connection has failed more than the preset number of times.

The determining of whether the transferring of the work log succeeds or fails may further include determining whether the transferring of the work log has failed more than a preset number of times when the response data corresponding to the reception of the work log is not received from the subsequent robot and determining whether the transferring of the work log is correct when the transferring has not failed more than the preset number of times and determining that the transferring of the work log fails when the transferring has failed more than the preset number of times.

The specific preset data may be a checksum generated based on work log data.

The communication link may be a communication protocol capable of unidirectional data transfer.

### BRIEF DESCRIPTION OF THE DRAWINGS

FIG. 1 is a block diagram illustrating a configuration of a robot working in shifts according to an embodiment of the present invention.

FIG. 2 is a structure diagram of a work log of a robot according to an embodiment of the present invention.

FIG. 3 is a reference diagram illustrating a shift rotation process for robots according to an embodiment of the present invention.

FIG. 4 is a reference diagram illustrating a shift rotation process for robots according to another embodiment of the present invention.

FIG. 5 is a flowchart illustrating a shift rotation method for multiple robots working in shifts according to an embodiment of the present invention.

FIGS. 6 and 7 are flowcharts illustrating a shift rotation method for multiple robots working in shifts according to another embodiment of the present invention.

FIGS. 8 to 10 are flowcharts illustrating sub-operations of an operation of determining whether the work log transfer of FIG. 6 is achieved normally.

### DETAILED DESCRIPTION OF EXEMPLARY EMBODIMENTS

Advantages and features of the present invention and implementation methods thereof will be clarified through the following embodiments described in detail with reference to the accompanying drawings. However, the present invention is not limited to embodiments disclosed herein and may be implemented in various different forms. The embodiments are provided for making the disclosure of the prevention invention thorough and for fully conveying the scope of the present invention to those skilled in the art. It is to be noted that the scope of the present invention is defined by the claims. The terminology used herein is for the purpose of describing particular embodiments only and is not intended to be limiting to the invention. As used herein, the singular forms “a,” “an,” and “one” include the plural unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

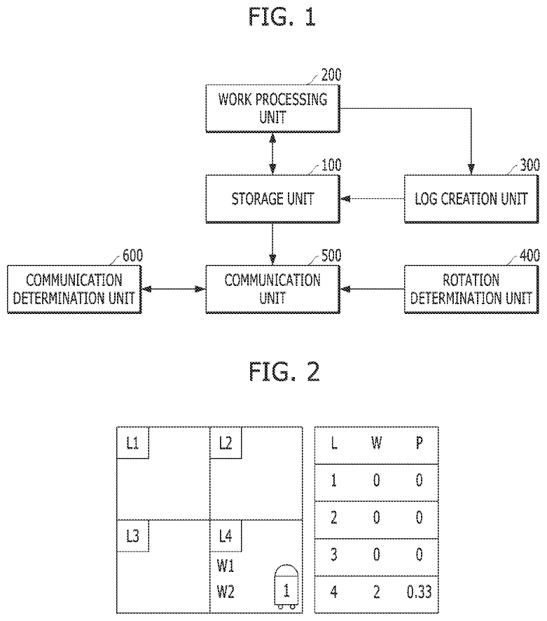

Hereinafter, exemplary embodiments of the present invention will be described in detail with reference to the accompanying drawings. FIG. 1 is a block diagram illustrating a configuration of a robot working in shifts according to an embodiment of the present invention.

As shown in FIG. 1, a robot working in shifts according to an embodiment of the present invention includes a storage unit 100, a work processing unit 200, a log creation unit 300, a rotation determination unit 400, and a communication unit 500.

According to an embodiment of the present invention, one robot works in one work area. Since one such robot works in a work area, at least one robot may be positioned in the work area to monitor the work area regardless of whether or not the robot itself is working.

According to an embodiment of the present invention, the work is determined based on location, and multiple pieces of work are separated in one work area by time.

Accordingly, the work log includes work positions and the current progress for each work position in the work area. Thus, when work is resumed based on the work log, the work may be resumed at a position determined on the basis of the work log and according to the progress of the work.

In this case, the storage unit 100 stores work plan information including a work position, work information, and workload information and a work log created by and received from a preceding work robot.

When the storage unit 100 has only the work plan information, the work processing unit 200 moves to the work area and then works on the basis of the work plan information.

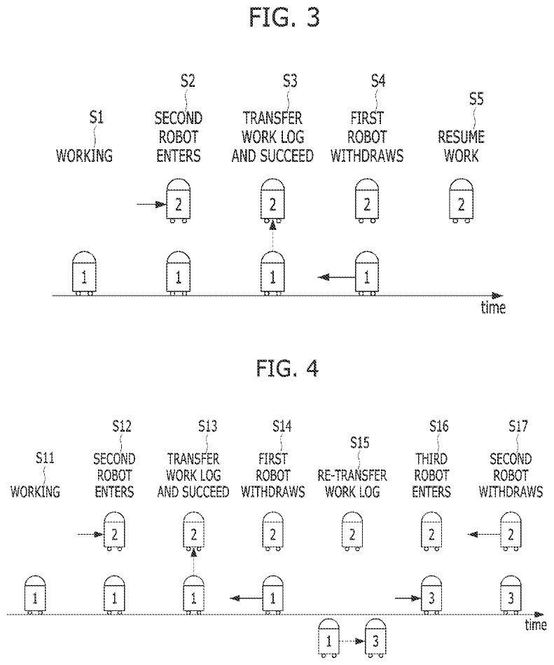

The log creation unit 300 detects workload performed through the work processing unit 200 and work position information regarding the work position to which the robot has moved for the work, creates a work log including the detected workload and work position information, and stores the created work log in the storage unit 100. FIG. 2 is a structure diagram of a work log of a robot according to an embodiment of the present invention.

Here, a work log has three fields, where L is a work position, W is the current work, and P is the progress of the current work.

The space of the whole work area is divided into regions, and the regions are named L1 to L4. In an embodiment of the present invention, the following description is based on L4.

It is assumed that L4 has two pieces of work W1 and W2 in chronological order and that for the current work progress, W1 is completed and W2 is 33%.

Meanwhile, the rotation determination unit 400 serves to determine a shift rotation period. Here, the shift rotation period may be differently determined by a robot work time, a robot work type, a robot work position, etc.

When the rotation determination unit 400 determines that a shift rotation time comes and a subsequent robot approaches the work area, the communication unit 500 may establish a communication link with the subsequent robot and transfer the work log stored in the storage unit 100 to the subsequent robot. Here, the communication link may use one of wired and wireless communication protocols.

Meanwhile, when a work log created by a preceding work robot is present in the storage unit 100, the work processing unit 200 may work in the corresponding work area in association with the work of the preceding work robot on the basis of the work log. That is, according to an embodiment of the present invention, the work may be resumed based on the work log forwarded to the robot. The work log of the robot may have different content and a different configuration depending on what kind of work the robot is doing.

Accordingly, according to an embodiment of the present invention, in an environment in which communication with a work robot is not smooth, it is possible for the robot to perform collaboration through shift rotation without losing the continuity of work in a given work area.

Meanwhile, the communication determination unit 600 determines whether log information is normally transmitted to a subsequent robot through the communication unit 500.

When the communication determination unit 600 determines that the log information of the work robot is not received by the subsequent robot, the communication unit 500 establishes a communication link with a standby robot located outside the work area and transfers the work log stored in the storage unit 100 to the standby robot.

Also, according to an embodiment of the present invention, efficient shift rotation between robots is possible even when a robot fails, and thus it is possible to effectively cope with the failure of the robot.

Meanwhile, when log information is received from the preceding work robot located outside the work area, the work processing unit 200 moves to the work area on the basis of the received log information.

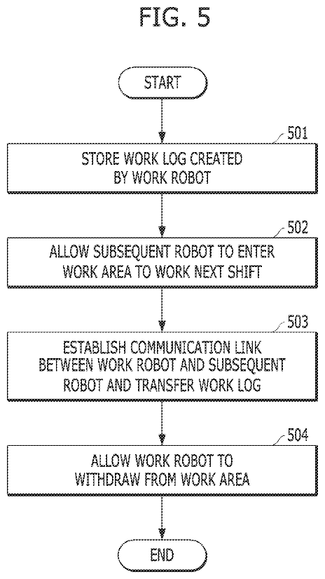

The shift rotation process for robots will be described below with reference to FIG. 3. A first robot is working in a work area (S). Here, the shift rotation between robots is determined according to a predetermined time period, a determined work progress, or the state of the first robot.

Subsequently, for shift rotation, a second robot enters the work area (S2).

Subsequently, the first robot and the second robot approach each other to transmit the work log. Connection establishment for work log transmission is performed, and the work log transmission is started (S3).

When the work log transmission succeeds, the first robot withdraws from the work area (4), and the second robot resumes work on the basis of the work log transmitted from the first robot (S5).

Also, when the subsequent robot moves into the work area, the work processing unit 200 does not work and returns from the work area.

When the work log information is not received from the preceding work robot after the work processing unit 200 moves to the work area on the basis of the work plan information stored in the storage unit 100, the work processing unit 200 performs only a monitoring function in the work area without working.

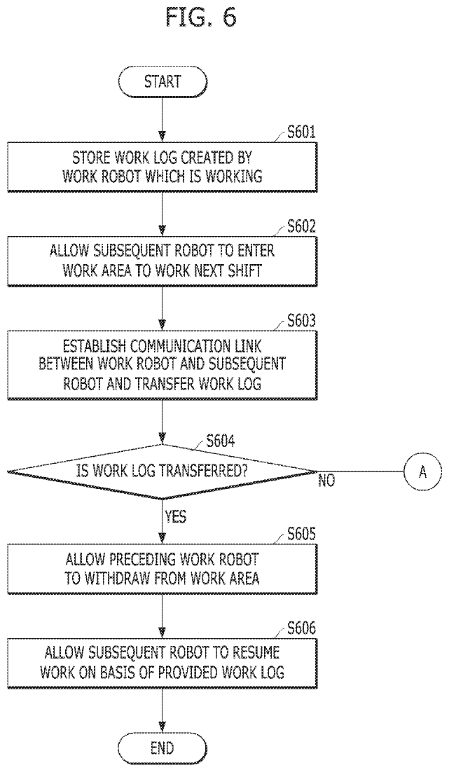

For example, pieces of work S1, S12, and S13 of FIG. 4 starting from the entrance of the second robot up to the transfer of the work log are the same as those (S, S2, and S3) of FIG. 3. However, when it is determined that the transfer of the work log has failed in the process of confirming the transfer of the work log (S14), the first robot withdraws while the second robot remains in the work area.

In this case, the second robot cannot resume work and thus performs only the work of monitoring the work area. The first robot, which has withdrawn, comes out of the work area and transfers the work log to a third robot (S15). When the work log is received, the third robot enters the work area (S16) and resumes work, and the second robot, which has monitored the work area, withdraws (S17).

As described above, according to an embodiment of the present invention, when a work log is not provided by the preceding work robot, the work is not performed in the work area. However, by performing only an environment monitoring function, it is possible to easily check the work area through communication when a standby robot enters the work area later.

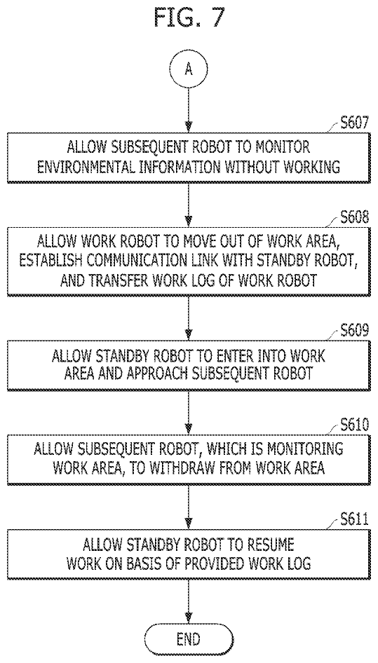

FIG. 5 is a flowchart illustrating a shift rotation method for multiple robots working in shifts according to an embodiment of the present invention.

As shown in FIG. 5, a work log created by a work robot, which is working, is stored (S501). Here, the work log may include labeling information of spaces into which the entire work area is divided, location information of the spaces, information on types of work performed over time, and information on progress of each piece of work.

Subsequently, when a shift rotation time comes, a subsequent robot enters the work area to work the next shift (S502). At this time, a communication link is established between a communication unit 500 of the work robot and a communication unit 500 of the subsequent robot, and the work robot transfers the work log to the subsequent robot (S503). Here, the communication link may use one of wired and wireless communication protocols.

The work robot withdraws from the work area (S504).

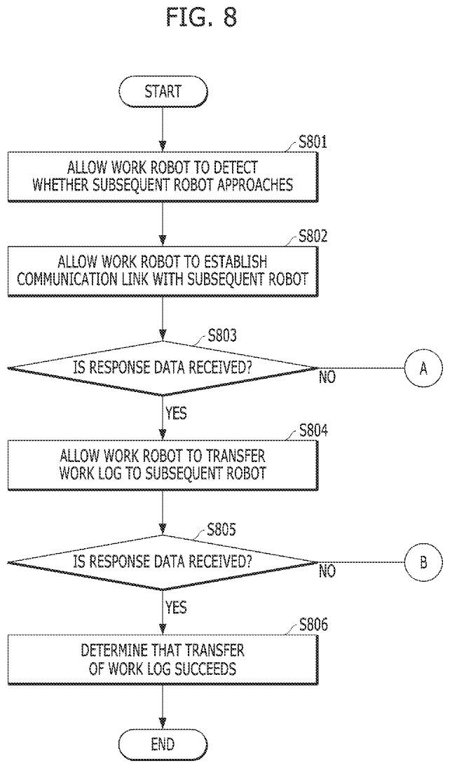

FIGS. 6 and 7 are flowcharts illustrating a shift rotation method for multiple robots working in shifts according to another embodiment of the present invention.

As shown in FIGS. 6 and 7, a work log created by a work robot, which is working, is stored (S601).

Subsequently, when a shift rotation time comes, a subsequent robot enters a work area to work the next shift (S602). At this time, a communication link is established between a communication unit 500 of the work robot and a communication unit 50 of the subsequent robot, and the work robot transfers the work log to the standby robot (S603).

Subsequently, it is determined whether the transfer of the work log succeeds or fails (S604).

When the transfer of the work log to the subsequent robot succeeds (YES) in the determination operation (S604), the work robot withdraws from the work area (S605).

Also, the subsequent robot resumes work on the basis of the work log provided by the work robot (S606).

When the transfer of the work log to the subsequent robot fails (NO) in the determination operation (S604), the standby robot does not work in the work area and monitors environmental information in the work area (S607).

Meanwhile, while the subsequent robot monitors the environmental information in the work area, the work robot moves out of the work area, establishes a communication link with a standby robot, and then transfers the work log of the work robot to the standby robot (S608).

Subsequently, the standby robot enters the work area and approaches the subsequent robot (S609).

Subsequently, the subsequent robot, which is monitoring the work area withdraws from the work area (S610), and the standby robot resumes work in the work area on the basis of the work log provided by the work robot (S611).

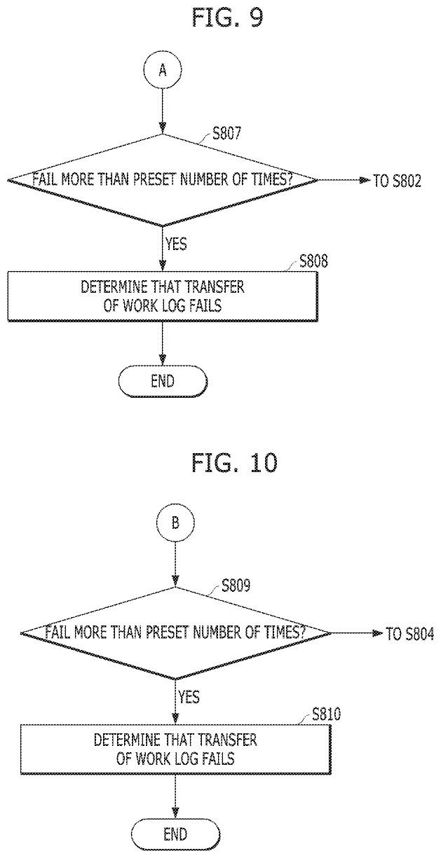

FIGS. 8 to 10 are flowcharts illustrating sub-operations of the operation of determining whether the transfer of the work log succeeds or fails in FIG. 6.

As shown in FIGS. 8 to 10, in the operation of determining whether the transfer of the work log succeeds or fails, first, the work robot detects whether the subsequent robot approaches within a preset range (S801).

Subsequently, the work robot establishes a communication link with the subsequent robot (S802).

In order to confirm the establishment of the connection with the subsequent robot, the work robot transfers specific preset data to the subsequent robot and then determines whether response data is received from the subsequent robot (S803).

When the response data is received (YES) in the operation of determining whether the response data is received from the subsequent robot (S803), the work robot transfers the work log of the work robot to the subsequent robot (S804).

Subsequently, the work robot determines whether response data corresponding to the reception of the work log of the work robot is received from the subsequent robot (S805).

When the response data corresponding to the reception of the work log is received (YES) in the operation of determining whether response data corresponding to the reception of the work log is received (S805), the work robot determines that the transfer of the work log succeeds (S806).

On the other hand, when the response data is not received (NO) in the operation of determining whether the response data is received from the subsequent robot (S803), the work robot determines whether the connection has failed more than a preset number of times (S807).

The processing proceeds to the operation of checking the connection for transferring the work log (S802) when the connection has not failed more than the preset number of times (NO), and the work robot determines that the transfer of the work log fails (S808) when the connection has failed more than the preset number of times (YES).

On the other hand, when the response data corresponding to the reception of the work log is not received (NO) in the operation of determining whether response data corresponding to the reception of the work log is received (S805), the work robot determines whether the transfer of the work log has failed more than a preset number of times (S809).

The processing proceeds to the operation of determining whether the transfer of the work log is correct (S804) when the transfer of the work log has not failed more than the preset number of times (YES), and the work robot determines that the transfer of the work log fails (S810) when the transfer of the work log has failed more than the preset number of times (NO).

Here, the specific preset data may be a checksum generated based on work log data.

Here, the communication link may be a communication protocol capable of unidirectional data transfer.

When one or more robots work in one work area the work area is divided into spaces through space division to set an environment in which one robot works, and the same is applicable even to an environment in which one or more robots work.

As an example, a work log transfer method and a success/failure check method are as follows.

The transfer of the work log may be achieved between robots on a one-to-one basis.

Robots approach each other to transfer the work log. However, when the robots approach within a certain range, a communication link is established to transfer the work log between the two robots. Here, the type of connection for transferring the work log includes any medium capable of unidirectional data transmission.

Then, after the communication link for transferring the work log is established, the establishment of the connection is checked. Here, a method of checking the establishment of the connection is to transfer and check specific predetermined data.

Then, in order to check the connection, the establishment is attempted continuously for a certain time or for a certain number of times, and when the connection is not established even after the certain time or the certain number of times, this is regarded as a failure.

When the connection succeeds, the transfer of the work log between robots is started. After the transfer is finished or after a certain period of time, it is checked whether the transfer succeeds. To check whether the transfer is correct, the work robot generates a small checksum on the basis of data of the work log to be transferred.

This checksum is transferred to the subsequent robot. Subsequently, it is necessary to repeatedly transfer the checksum to increase the certainty of the checksum transfer. After the checksum is transferred, the checksum is compared to a checksum generated after the transfer of the work log is completed. In this way, it is possible to check whether the transfer succeeds.

Subsequently, in order to check the transfer, the transfer is attempted continuously for a certain time or for a certain number of times, and when the same checksum cannot be generated even after the certain time or the certain number of times, this is regarded as a failure.

After it is checked whether the transfer succeeds or fails, the allocation of a work robot is performed through the process shown in FIGS. 3 and 4.

When the transfer of the work log and the placement of the robot are finished, a subsequent robot can continue to do incomplete work according to the transferred work log.

According to an embodiment of the present invention, when a robot fails in a process of performing collaboration through shift rotation without losing continuity in a given environment, it is possible to efficiently cope with the failure.

Also, according to an embodiment of the present invention, when an abnormality occurs in a shift rotation process, it is possible to detect and respond to the abnormality by placing at least one robot that monitors a work area.

Each step included in the learning method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Although the configuration of the present invention has been described in detail with reference to the accompanying drawings, this is merely an example, and it will be appreciated by those skilled in the art that various modifications and changes may be made therein without departing from the spirit of the present invention. Accordingly, the scope of the present invention should not be limited to the above-described embodiments. Rather, it is to be determined only by the appended claims.

What is claimed is:

1. A robot working in shifts, the robot comprising:
a storage unit configured to store received work plan information including a work position, work information, and workload information, and a work log created and received by a preceding work robot;
a work processing unit configured to move to a work area and then work on the basis of work plan information when only the work plan information is present in the storage unit;
a log creation unit configured to detect workload performed through the work processing unit and work position information regarding a work position to which the robot has moved for work, create a work log including the detected workload and work position information, and store the created work log in the storage unit;
a rotation determination unit configured to determine a shift rotation cycle; and
a communication unit configured to establish a communication link with a subsequent robot and transfer the work log stored in the storage unit to the subsequent robot when the rotation determination unit determines that a shift rotation time comes and the subsequent robot approaches the work area.

2. The robot of claim 1, wherein when a work log created by the preceding work robot is present in the storage unit, the work processing unit works in association with work of the preceding work robot on the basis of the work log.

3. The robot of claim 1, further comprising a communication determination unit configured to determine whether log information is normally transferred to the subsequent robot through the communication unit,
wherein when the communication determination unit determines that the log information of the work robot is not received, the communication unit establishes a communication link with a standby robot located outside the work area and transfers the work log stored in the storage unit to the standby robot.

4. The robot of claim 3, wherein when the log information is received from the preceding work robot outside the work area, the work processing unit moves to the work area on the basis of the received log information.

5. The robot of claim 1, wherein when work log information is not received from the preceding work robot after the work processing unit moves to the work area on the basis of the work plan information stored in the storage unit, the work processing unit performs only a monitoring function in the work area without working.

6. The robot of claim 5, wherein when the subsequent robot moves into the work area, the work processing unit does not work and returns from the work area.

7. The robot of claim 1, wherein the work log includes labeling information of spaces into which the entire work area is divided, location information of the spaces, information on types of work performed over time, and information on progress of each piece of work.

8. The robot of claim 1, wherein the communication link uses one of wired and wireless communication protocols.

9. A shift rotation method for multiple robots working in shifts, the shift rotation method comprising:
storing a work log created by a work robot, which is working;
establishing a communication link between a communication unit of the work robot and a communication unit of a subsequent robot and transferring the work log to the subsequent robot when the subsequent robot enters a work area to work a next shift; and
allowing the work robot to withdraw from the work area.

10. The shift rotation method of claim 9, wherein the work log includes labeling information of spaces into which the entire work area is divided, location information of the spaces, information on types of work performed over time, and information on progress of each piece of work.

11. The shift rotation method of claim 9, wherein the communication link uses one of wired and wireless communication protocols.

12. A shift rotation method for multiple robots working in shifts, the shift rotation method comprising:
storing a work log created by a work robot, which is working;
establishing a communication link between a communication unit of the work robot and a communication unit of a subsequent robot and transferring the work log to the subsequent robot when the subsequent robot enters a work area to work a next shift;
determining whether the transferring of the work log succeeds or fails;
allowing the work robot to withdraw from the work area when it is determined that the transferring of the work log succeeds; and
allowing the subsequent robot to resume work on the basis of the work log provided by the work robot.

13. The shift rotation method of claim 12, further comprising allowing the subsequent robot to monitor environmental information in the work area without working in the work area when it is determined that the work log of the work robot is not transferred to the subsequent robot.

14. The shift rotation method of claim 13, further comprising:
allowing the subsequent robot to monitor the environmental information in the work area and allowing the work robot to move out of the work area;
allowing the work robot to establish a communication link with a standby robot outside the work area and transfer the work log of the work robot to the standby robot;
allowing the standby robot to enter the work area and approach the subsequent robot; and
allowing the subsequent robot, which is monitoring the work area, to withdraw from the work area and allowing the standby robot to resume work in the work area on the basis of the work log provided by the work robot.

15. The shift rotation method of claim 12, wherein the determining of whether the transferring of the work log succeeds or fails comprises:
allowing the work robot to detect whether the subsequent robot approaches within a preset range;
allowing the work robot to establish a communication link with the subsequent robot;
allowing the work robot to transfer specific preset data to the subsequent robot and then determine whether response data is received from the subsequent robot to check the establishment of the connection with the subsequent robot;
allowing the work robot to transfer the work log of the work robot to the subsequent robot when it is determined that the response data is received from the subsequent robot;
allowing the work robot to determine whether response data corresponding to the reception of the work log of the work robot is received from the subsequent robot; and
determining that the transferring of the work log succeeds when it is determined that the response data corresponding to the reception of the work log is received from the subsequent robot.

16. The shift rotation method of claim 15, wherein the determining of whether the transferring of the work log succeeds or fails further comprises:
determining whether the connection has failed more than a preset number of times when it is determined that the response data is not received from the subsequent robot; and
checking the connection for transferring the work log when the connection has not failed more than the preset number of times and determining that the transferring of the work log fails when the connection has failed more than the preset number of times.

17. The shift rotation method of claim 15, wherein the determining of whether the transferring of the work log succeeds or fails further comprises:
determining whether the transferring of the work log has failed more than a preset number of times when the response data corresponding to the reception of the work log is not received from the subsequent robot; and
determining whether the transferring of the work log is correct when the transferring has not failed more than the preset number of times and determining that the transferring of the work log fails when the transferring has failed more than the preset number of times.

18. The shift rotation method of claim 15, wherein the specific preset data is a checksum generated based on work log data.

19. The shift rotation method of claim 14, wherein the communication link is a communication protocol capable of unidirectional data transfer.
